(19) United States
(12) Patent Application Publication
(10) Pub. No.: US 2012/0107011 A1
(43) Pub. Date: May 3, 2012

(54) REDUCING CONTAMINATION BY REGULATING FLOW

(76) Inventors: KENNETH J. BROWN, Penfield, NY (US); Michael T. Dobbertin, Honeoye, NY (US)

(21) Appl. No.: 12/914,118

(22) Filed: Oct. 28, 2010

(51) Int. Cl. G03G 21/00

(52) U.S. Cl. 399/98

(57) ABSTRACT

Apparatus for retaining a contaminating substance in a working volume containing a gas includes a movable surface disposed adjacent to the working volume. A barrier is spaced apart from the surface ahead of the working volume in the direction of motion of the surface so that a gap is defined between the barrier and the surface. The gap is selected so that a stream of gas is carried by the moving surface through the gap into the working volume and the contaminating substance in the working volume is urged away from the gap, thereby reducing flow of the contaminating substance through the gap.

### FIELD OF THE INVENTION

This invention pertains to the field of fluid mechanics and more particularly to managing flow through apertures.

### BACKGROUND OF THE INVENTION

Electrophotography is a useful process for printing images on a receiver (or “imaging substrate”), such as a piece or sheet of paper or another planar medium, glass, fabric, metal, or other objects as will be described below. In this process, an electrostatic latent image is formed on a photoreceptor by uniformly charging the photoreceptor and then discharging selected areas of the uniform charge to yield an electrostatic charge pattern corresponding to the desired image (a “latent image”).

After the latent image is formed, charged toner particles are brought into the vicinity of the photoreceptor and are attracted to the latent image to develop the latent image into a visible image. Note that the visible image may not be visible to the naked eye depending on the composition of the toner particles (e.g., clear toner).

After the latent image is developed into a visible image on the photoreceptor, a suitable receiver is brought into juxtaposition with the visible image. A suitable electric field is applied to transfer the toner particles of the visible image to the receiver to form the desired print image on the receiver. The imaging process is typically repeated many times with reusable photoreceptors.

The receiver is then removed from its operative association with the photoreceptor and subjected to heat or pressure to permanently fix (“fuse”) the print image to the receiver. Plural print images, e.g., of separations of different colors, are overlaid on one receiver before fusing to form a multi-color print image on the receiver.

Electrophotographic (EP) printers typically transport the receiver past the photoreceptor to form the print image. The direction of travel of the receiver is referred to as the slow-scan, process, or in-track direction. This is typically the vertical (Y) direction of a portrait-oriented receiver. The direction perpendicular to the slow-scan direction is referred to as the fast-scan, cross-process, or cross-track direction, and is typically the horizontal (X) direction of a portrait-oriented receiver. “Scan” does not imply that any components are moving or scanning across the receiver; the terminology is conventional in the art.

In most electrophotographic development systems, more toner is supplied to the photoreceptor than is necessary to develop the visible image. Much of the excess toner can leave the confines of the development station applying the toner to the photoreceptor. This toner can contaminate other areas of the imaging module, reducing image quality and printer reliability. Toner can leave the development station through the leading edge, where the charged, un-toned photoreceptor enters the station, or through the trailing edge, where the visible image on the photoreceptor is exiting the development station. Various attempts have been made to reduce contamination.

For example, seals have been employed on the development station. These can include flaps, plushes, or brushes that make direct contact with the surface of the photoconductor. Seals are generally located on the leading edge of the development station, before development occurs, since the nap created by the developer can seal the trailing edge. Elastomeric seals can be formed from polyethylene terephthalate (PET), polyurethane (PUR), polyphenylether (PPE), polycarbonate (PC), polyethylene (PE), polypropylene (PP), and other materials known in the art. Seals can also be formed from foams, fabrics, rigid plastics, or metals. However, more rigid seal materials increase the risk of damage to the roller in contact with the seal.

U.S. Pat. No. 5,467,174 to Koga describes a sealing member provided at the opening of a development unit and in light contact therewith. Even though the contact is light, mechanical wear can still occur between the seal and the member it is in contact with.

Commonly-assigned U.S. Pat. No. 5,991,568 to Ziegelmuller et al., the disclosure of which is incorporated herein by reference, describes reducing the amount of toner escaping from a cleaning housing. Ziegelmuller points out that foam and brush seals, and upstream sealing blades, have been employed. Ziegelmuller describes a dust seal blade that creates a cavity in front of the cleaning blade to capture airborne toner dust, thereby reducing contamination of a cleaning blade engaged with the surface to be cleaned. Although this device is useful, it uses a dust seal blade in contact with the surface to be cleaned, and therefore can lead to mechanical wear.

U.S. Publication No. 2010/0028045 to Kawakami et al. describes a cleaning device for a rotary member. The cleaning device includes a seal and a blade pressed against the rotary member and seal extending along the length of the rotary member. The gaps between the seal and the blade at each end of the rotary member are sealed by pressing respective end seals against the rotary member. However, the mechanical contact between the end seal and the rotary member can wear or damage the rotary member. Kawakami suggests that a very limited range of materials (foams, fabrics) can be used to reduce these risks; these limits reduce opportunities to combine part functions and can therefore lead to increased size, weight, and cost of a printer.

These devices provide a positive seal and prevent the loss of toner dust from the development station. However, mechanical-contact seals can collect material between the seal and the photoconductor, which can in turn scratch the surface of the photoconductor, reducing image quality. Various alternative seal techniques have been tried.

GB 2 098 095 A to Kopp et al. describes a toner dust sealing plate extending close to the photoconductor at the trailing edge of the development station and a vacuum system to reduce dusting out of the leading edge of the development station. Vacuum systems can be noisy and expensive. Moreover, vacuum systems need to be carefully tuned to avoid sucking toner out of the development station.

GB 2 098 096 A to Maier et al. describes a guide means that divides the development station into upper and lower parts. Toner flows from the upper to the lower part around both ends of the guide means, so dust generated in the lower part cannot escape to the upper part. This scheme requires a more complicated development station and can limit the functions that can be performed by or in the development station.

Commonly-assigned U.S. Pat. No. 6,385,415 to Hilbert et al., the disclosure of which is incorporated herein by reference, describes compliant lip seals around roller axles, and permanent magnets used as magnetic seals to prevent leakage of developer material from the ends of the development roller. Although useful, this requires magnets; less-expensive seal materials are desirable. Moreover, magnetic seals can form a “brush” by attracting magnetic material (e.g., developer). The brush can contact the moving member and cause wear or damage thereto.

There is a continuing need, therefore, for an inexpensive seal that reduces toner contamination without constraining the design of the printer, and without increasing wear on, or the risk of damage to, the photoconductor.

### SUMMARY OF THE INVENTION

In addition to the above, there is also an ongoing need for a solution to the problem of preventing backflow of material, such as toner or ink, past a seal in the direction opposite that intended. According to various embodiments described herein, air set in motion by nothing more than the movement of a surface is used to retain movable contaminants in a working volume adjacent to the surface.

According to the present invention, there is provided apparatus for retaining a contaminating substance in a working volume containing a gas, comprising:

a. a movable surface disposed adjacent to the working volume; and

b. a barrier spaced apart from the surface ahead of the working volume in the direction of motion of the surface so that a gap is defined between the barrier and the surface; and

c. wherein the gap is selected so that a stream of gas is carried by the moving surface through the gap into the working volume and the contaminating substance in the working volume is urged away from the gap, thereby reducing flow of the contaminating substance through the gap.

An advantage of this invention is that it reduces backflow and contains toner without requiring fans, blowers, vacuums, or other noisy, low-MTBF components. It also does not require brushes, blades, or other mechanical seals that wear and that cause wear on or damage to a surface on which colorant is being deposited. By reducing wear on surfaces, the invention reduces the generation of particulate contaminants that can chip or flake off surfaces. It does not bring coarse particles which can scratch the surface into contact with the surface. It reduces triboelectric charging of members which can produce or attract contaminants. It reduces contamination of parts of a printer but does not create large amounts of drag on the movable surface. By not producing large drag forces, it reduces heating of the surface due to friction.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is an elevational cross-section of an electrophotographic reproduction apparatus suitable for use with this invention;

FIG. 2 is an elevational cross-section of one printing module of the apparatus of FIG. 1;

FIG. 3 is an elevational cross-section of toner heating apparatus according to an embodiment; and

FIG. 4 is an elevational cross-section of apparatus for retaining a contaminating substance in a working volume according to an embodiment.

The attached drawings are for purposes of illustration and are not necessarily to scale.

### DETAILED DESCRIPTION OF THE INVENTION

FIG. 4 shows an apparatus for retaining a contaminating substance 409 in working volume 250 according to an embodiment. A “contaminating substance,” or “contaminant,” as used herein, is any matter (solid, liquid, gas, plasma, or combination, e.g., suspension) that can contaminate a particular surface or part on contact therewith. Not all contaminating substances or contaminants deposit on or contaminate all surfaces or parts, but such substances have the potential to do so. It is therefore desirable to restrict the passage of contaminating substances out of working volumes in which they are found, and in which they are preferably contained. An example of undesirable contamination is the deposition of toner particles on a photodiode in a densitometer in a printer, as described in U.S. Pat. No. 5,903,800 to Stern et al., issued May 11, 1999, the disclosure of which is incorporated herein by reference.

Movable surface 410 moves in direction 415 and is disposed adjacent to working volume 250. The length of the arrow indicating direction 415 is not indicative of the speed of surface 410. Working volume 250 contains a gas (not shown); for example, gases including nitrogen such as N₂ and air can be used.

Barrier 454 is spaced apart from moving surface 410 ahead of working volume 250 in direction 415 of motion of surface 410. Gap 456 is therefore defined; it is the opening between barrier 454 and surface 410. Gap 456 can also be described as an opening or aperture. As surface 410 moves, gas (or liquid, if the system is submerged) is drawn with it by friction at the surface, forming a laminar-flow boundary layer over the surface. Barrier 454 preferably does not contact surface 410; in other embodiments, barrier 454 contacts surface 410 at some points, but not across the entire width of surface 410.

Gap 456 can have any shape or size, subject to one constraint: gap 456 is selected so that a stream 420 of gas is carried by moving surface 410 through gap 456 into working volume 250. This inflow causes the contaminating substance in working volume 250, represented in the example of FIG. 4 as contaminating substance particles 409, to be urged away from gap 456. The force on particles 409 from stream 420 is shown using hollow-headed arrows in FIG. 4. This reduces flow of the contaminant through the gap out of working volume 250. Any motion of particles 409 or other contaminants through gap 456 out of working volume 250 is represented by backflow 404, and requires a force stronger than the force away from the gap provided by stream 420. The size and shape of gap 456 and the speed of motion of surface 410 are selected to provide stream 420 that will retain contaminating substances in working volume 250, or in any case substantially reduce the amount of contaminant undergoing backflow 404.

In various embodiments, the motion of surface 410 with respect to the gas around it creates a boundary layer, represented graphically with flow velocity vectors 470 having lengths representative of the gas speed at the tail of the arrow. The gas away from surface 410 is stationary in this example. Therefore, the gas in contact with surface 410 is moving at the same speed as surface 410, and the gas far enough away from surface 410 (i.e., beyond the boundary layer) is stationary. Gap 456 is entirely within the boundary layer. For example, gap 456 can be selected to have a height at which the speed of air being drawn by moving surface 410 is greater than 1% of the speed of moving surface 410.

In various embodiments, the thickness 434 of barrier 454 is selected to provide desired flow characteristics through gap 456. Thicker barriers can be used to provide greater reduction of turbulence in stream 420. The leading and trailing edges of barrier 454 can be beveled, rounded, sharpened, or any combination, to reduce turbulence at the inlet and increase it at the outlet of gap 456, or to provide other desired aerodynamic properties. Gap 456 can be a venturi, e.g., by shaping the face of barrier 454 closest to surface 410 to provide variable gap surface area at different points across thickness 434. Barrier 454 can also include a plurality of notches in the face closest to surface 410 perpendicular to, or at a desired angle to, surface 410. This provides increased control of the pressure differential across gap 456.

In various embodiments, the contaminant is of a selected type (e.g., toner particles), and there is more material, or a higher density of material, of the selected type in working volume 250 than in an external volume on the opposite side of barrier 454 from working volume 250.

In various embodiments, barrier 454 has surface 455 adjacent to working volume 250. The contaminant substantially does not adhere to surface 455. This can be achieved by coating or forming surface 455 with a low-adhesion material such as PTFE (sold as TEFLON), by smoothing surface 455, or by providing an electric charge or magnetic field on surface 455 that repels the contaminant. This can also be achieved by orienting the apparatus to take advantage of external forces. In an embodiment, barrier 454 is above working volume 250 and surface 410 is moving downward (i.e., at an angle below the horizontal, but not necessarily straight down). Since direction 415 points below horizontal, gravity will pull contaminants in working volume 250 away from barrier 454 and surface 455.

In various embodiments, air flow through the gap is adjusted. In an embodiment, stream 420 is more turbulent downstream of gap 456 (i.e., past gap 456 in direction 415) than in gap 456. Laminar flow through gap 456 retains contaminants in working volume 250, and turbulence downstream of gap 456 reduces the likelihood that contaminants will be deposited on surface 455.

In various embodiments, the motion of surface 410 is the only provider of motive force to stream 420. In these embodiments, the stream of gas is not urged into the working volume by a fan or blower.

In various embodiments, enclosure 452 defines or is attached to barrier 454. Enclosure 452 encloses the working volume. Enclosure 452 is not necessarily closed everywhere except gap 456. In some embodiments, enclosure 452 includes one or more exit port(s) 499 through which gas leaves working volume 250. The surface area of the exit port(s) 499 is preferably greater than or equal to the surface area of gap 456. This reduces pressure build-up in working volume 250 or inside enclosure 452. Built-up pressure provides a force in the direction of backflow 404, so reducing that force advantageously retains contaminants in working volume 250. In various embodiments, the surfaces of enclosure 452, barrier 454, and moving surface 410 that are exposed to contaminants in working volume 250 are selected to be substantially unaffected by contamination from those contaminants (although they can be vulnerable to contamination by other contaminants). Examples of size ranges of contaminant particles are those ranges given below for toner particles. Carrier particles and particles forming part of the surface treatment can also become contaminants; the latter can be 10-100 nm in mean diameter (which can be measured, e.g., with a scanning electron microscope).

In various embodiments, some of which will be described below, moving surface 410 is a closed surface of a rotatable member, such as a drum or belt. Such surfaces can be closed surfaces of belts or drums in an electrophotographic printer. The surface can also be an imaging surface, i.e., the side that will be printed on, of a receiver web in a printer. In various embodiments useful with printers, the contaminant can include a colorant such as a dye or pigment. Colorants are very useful when applied to a receiver to produce prints desired by a user, but can reduce image quality when deposited on the surfaces of drums, belts, and other internal components of a printer. They are therefore potential contaminants of those components. The contaminants can be toner particles, carrier particles, ink drops (in water or solvent), solid or molten wax drops, wax or ink streams, or liquid sheets (e.g., in a curtain coater).

As used herein, the terms “parallel” and “perpendicular” have a tolerance of ±10°.

As used herein, “sheet” is a discrete piece of media, such as receiver media for an electrophotographic printer (described below). Sheets have a length and a width. Sheets are folded along fold axes, e.g., positioned in the center of the sheet in the length dimension, and extending the full width of the sheet. The folded sheet contains two “leaves,” each leaf being that portion of the sheet on one side of the fold axis. The two sides of each leaf are referred to as “pages.” “Face” refers to one side of the sheet, whether before or after folding.

As used herein, “toner particles” are particles of one or more material(s) that are transferred by an EP printer to a receiver to produce a desired effect or structure (e.g., a print image, texture, pattern, or coating) on the receiver. Toner particles can be ground from larger solids, or chemically prepared (e.g., precipitated from a solution of a pigment and a dispersant using an organic solvent), as is known in the art. Toner particles can have a range of diameters, e.g., less than 8 μm, on the order of 10-15 μm, up to approximately 30 μm, or larger (“diameter” refers to the volume-weighted median diameter, as determined by a device such as a Coulter Multisizer).

“Toner” refers to a material or mixture that contains toner particles, and that can form an image, pattern, or coating when deposited on an imaging member including a photoreceptor, a photoconductor, or an electrostatically-charged or magnetic surface. Toner can be transferred from the imaging member to a receiver. Toner is also referred to in the art as marking particles, dry ink, or developer, but note that herein “developer” is used differently, as described below. Toner can be a dry mixture of particles or a suspension of particles in a liquid toner base.

Toner includes toner particles and can include other particles. Any of the particles in toner can be of various types and have various properties. Such properties can include absorption of incident electromagnetic radiation (e.g., particles containing colorants such as dyes or pigments), absorption of moisture or gasses (e.g., desiccants or getters), suppression of bacterial growth (e.g., biocides, particularly useful in liquid-toner systems), adhesion to the receiver (e.g., binders), electrical conductivity or low magnetic reluctance (e.g., metal particles), electrical resistivity, texture, gloss, magnetic remnance, florescence, resistance to etchants, and other properties of additives known in the art.

In single-component or monocomponent development systems, “developer” refers to toner alone. In these systems, none, some, or all of the particles in the toner can themselves be magnetic. However, developer in a monocomponent system does not include magnetic carrier particles. In dual-component, two-component, or multi-component development systems, “developer” refers to a mixture including toner particles and magnetic carrier particles, which can be electrically-conductive or -non-conductive. Toner particles can be magnetic or non-magnetic. The carrier particles can be larger than the toner particles, e.g., 15-20 μm or 20-300 μm in diameter. A magnetic field is used to move the developer in these systems by exerting a force on the magnetic carrier particles. The developer is moved into proximity with an imaging member or transfer member by the magnetic field, and the toner or toner particles in the developer are transferred from the developer to the member by an electric field, as will be described further below. The magnetic carrier particles are not intentionally deposited on the member by action of the electric field; only the toner is intentionally deposited. However, magnetic carrier particles, and other particles in the toner or developer, can be unintentionally transferred to an imaging member. Developer can include other additives known in the art, such as those listed above for toner. Toner and carrier particles can be substantially spherical or non-spherical.

The electrophotographic process can be embodied in devices including printers, copiers, scanners, and facsimiles, and analog or digital devices, all of which are referred to herein as “printers.” Various aspects of the present invention are useful with electrostatographic printers such as electrophotographic printers that employ toner developed on an electrophotographic receiver, and ionographic printers and copiers that do not rely upon an electrophotographic receiver. Electrophotography and ionography are types of electrostatography (printing using electrostatic fields), which is a subset of electrography (printing using electric fields).

A digital reproduction printing system (“printer”) typically includes a digital front-end processor (DFE), a print engine (also referred to in the art as a “marking engine”) for applying toner to the receiver, and one or more post-printing finishing system(s) (e.g., a UV coating system, a glosser system, or a laminator system). A printer can reproduce pleasing black-and-white or color onto a receiver. A printer can also produce selected patterns of toner on a receiver, which patterns (e.g., surface textures) do not correspond directly to a visible image. The DFE receives input electronic files (such as Postscript command files) composed of images from other input devices (e.g., a scanner, a digital camera). The DFE can include various function processors, e.g., a raster image processor (RIP), image positioning processor, image manipulation processor, color processor, or image storage processor. The DFE rasterizes input electronic files into image bitmaps for the print engine to print. In some embodiments, the DFE permits a human operator to set up parameters such as layout, font, color, paper type, or post-finishing options. The print engine takes the rasterized image bitmap from the DFE and renders the bitmap into a form that can control the printing process from the exposure device to transferring the print image onto the receiver. The finishing system applies features such as protection, glossing, or binding to the prints. The finishing system can be implemented as an integral component of a printer, or as a separate machine through which prints are fed after they are printed.

The printer can also include a color management system which captures the characteristics of the image printing process implemented in the print engine (e.g., the electrophotographic process) to provide known, consistent color reproduction characteristics. The color management system can also provide known color reproduction for different inputs (e.g., digital camera images or film images).

In an embodiment of an electrophotographic modular printing machine useful with the present invention, e.g., the NEXPRESS 2100 printer manufactured by Eastman Kodak Company of Rochester, N.Y., color-toner print images are made in a plurality of color imaging modules arranged in tandem, and the print images are successively electrostatically transferred to a receiver adhered to a transport web moving through the modules. Colored toners include colorants, e.g., dyes or pigments, which absorb specific wavelengths of visible light. Commercial machines of this type typically employ intermediate transfer members in the respective modules for transferring visible images from the photoreceptor and transferring print images to the receiver. In other electrophotographic printers, each visible image is directly transferred to a receiver to form the corresponding print image.

Electrophotographic printers having the capability to also deposit clear toner using an additional imaging module are also known. The provision of a clear-toner overcoat to a color print is desirable for providing protection of the print from fingerprints and reducing certain visual artifacts. Clear toner uses particles that are similar to the toner particles of the color development stations but without colored material (e.g., dye or pigment) incorporated into the toner particles. However, a clear-toner overcoat can add cost and reduce color gamut of the print; thus, it is desirable to provide for operator/user selection to determine whether or not a clear-toner overcoat will be applied to the entire print. A uniform layer of clear toner can be provided. A layer that varies inversely according to heights of the toner stacks can also be used to establish level toner stack heights. The respective color toners are deposited one upon the other at respective locations on the receiver and the height of a respective color toner stack is the sum of the toner heights of each respective color. Uniform stack height provides the print with a more even or uniform gloss.

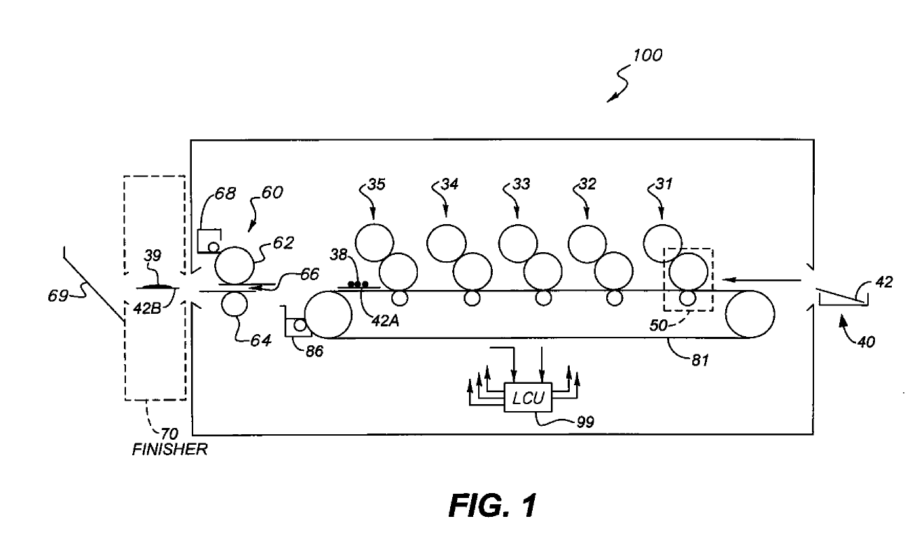

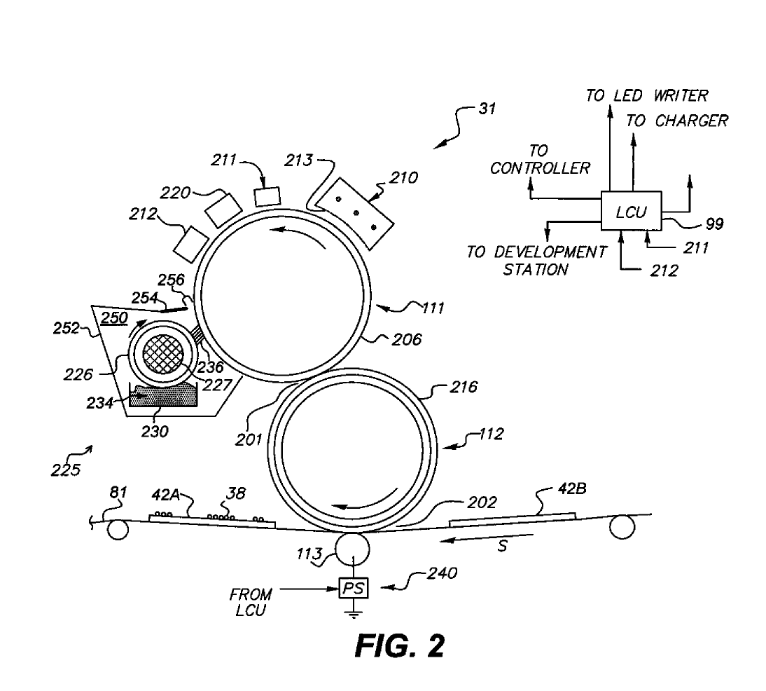

FIGS. 1-2 are elevational cross-sections showing portions of a typical electrophotographic printer 100 useful with the present invention. Printer 100 is adapted to produce images, such as single-color (monochrome), CMYK, or pentachrome (five-color) images, on a receiver (multicolor images are also known as “multi-component” images). Images can include text, graphics, photos, and other types of visual content. One embodiment of the invention involves printing using an electrophotographic print engine having five sets of single-color image-producing or -printing stations or modules arranged in tandem, but more or less than five colors can be combined on a single receiver. Other electrophotographic writers or printer apparatus can also be included. Various components of printer 100 are shown as rollers; other configurations are also possible, including belts.

Referring to FIG. 1, printer 100 is an electrophotographic printing apparatus having a number of tandemly-arranged electrophotographic image-forming printing modules 31, 32, 33, 34, 35, also known as electrophotographic imaging subsystems. Each printing module produces a single-color toner image for transfer using a respective transfer subsystem 50 (for clarity, only one is labeled) to a receiver 42 successively moved through the modules. Receiver 42 is transported from supply unit 40, which can include active feeding subsystems as known in the art, into printer 100. In various embodiments, the visible image can be transferred directly from an imaging roller to a receiver, or from an imaging roller to one or more transfer roller(s) or belt(s) in sequence in transfer subsystem 50, and thence to receiver 42. Receiver 42 is, for example, a selected section of a web of, or a cut sheet of, planar media such as paper or transparency film.

Each receiver, during a single pass through the five modules, can have transferred in registration thereto up to five single-color toner images to form a pentachrome image. As used herein, the term “pentachrome” implies that in a print image, combinations of various of the five colors are combined to form other colors on the receiver at various locations on the receiver, and that all five colors participate to form process colors in at least some of the subsets. That is, each of the five colors of toner can be combined with toner of one or more of the other colors at a particular location on the receiver to form a color different than the colors of the toners combined at that location. In an embodiment, printing module 31 forms black (K) print images, 32 forms yellow (Y) print images, 33 forms magenta (M) print images, and 34 forms cyan (C) print images.

Printing module 35 can form a red, blue, green, or other fifth print image, including an image formed from a clear toner (i.e. one lacking pigment). The four subtractive primary colors, cyan, magenta, yellow, and black, can be combined in various combinations of subsets thereof to form a representative spectrum of colors. The color gamut or range of a printer is dependent upon the materials used and process used for forming the colors. The fifth color can therefore be added to improve the color gamut. In addition to adding to the color gamut, the fifth color can also be a specialty color toner or spot color, such as for making proprietary logos or colors that cannot be produced with only CMYK colors (e.g., metallic, fluorescent, or pearlescent colors), or a clear toner or tinted toner. Tinted toners absorb less light than they transmit, but do contain pigments or dyes that move the hue of light passing through them towards the hue of the tint. For example, a blue-tinted toner coated on white paper will cause the white paper to appear light blue when viewed under white light, and will cause yellows printed under the blue-tinted toner to appear slightly greenish under white light.

Receiver 42A is shown after passing through printing module 35. Print image 38 on receiver 42A includes unfused toner particles.

Subsequent to transfer of the respective print images, overlaid in registration, one from each of the respective printing modules 31, 32, 33, 34, 35, receiver 42A is advanced to a fuser 60, i.e. a fusing or fixing assembly, to fuse print image 38 to receiver 42A. Transport web 81 transports the print-image-carrying receivers to fuser 60, which fixes the toner particles to the respective receivers by the application of heat and pressure. The receivers are serially de-tacked from transport web 81 to permit them to feed cleanly into fuser 60. Transport web 81 is then reconditioned for reuse at cleaning station 86 by cleaning and neutralizing the charges on the opposed surfaces of the transport web 81. A mechanical cleaning station (not shown) for scraping or vacuuming toner off transport web 81 can also be used independently or with cleaning station 86. The mechanical cleaning station can be disposed along transport web 81 before or after cleaning station 86 in the direction of rotation of transport web 81.

Fuser 60 includes a heated fusing roller 62 and an opposing pressure roller 64 that form a fusing nip 66 therebetween. In an embodiment, fuser 60 also includes a release fluid application substation 68 that applies release fluid, e.g., silicone oil, to fusing roller 62. Alternatively, wax-containing toner can be used without applying release fluid to fusing roller 62. Other embodiments of fusers, both contact and non-contact, can be employed with the present invention. For example, solvent fixing uses solvents to soften the toner particles so they bond with the receiver. Photoflash fusing uses short bursts of high-frequency electromagnetic radiation (e.g., ultraviolet light) to melt the toner. Radiant fixing uses lower-frequency electromagnetic radiation (e.g., infrared light) to more slowly melt the toner. Microwave fixing uses electromagnetic radiation in the microwave range to heat the receivers (primarily), thereby causing the toner particles to melt by heat conduction, so that the toner is fixed to the receiver.

The receivers (e.g., receiver 42B) carrying the fused image (e.g., fused image 39) are transported in a series from the fuser 60 along a path either to a remote output tray 69, or back to printing modules 31, 32, 33, 34, 35 to create an image on the backside of the receiver, i.e. to form a duplex print. Receivers can also be transported to any suitable output accessory. For example, an auxiliary fuser or glossing assembly can provide a clear-toner overcoat. Printer 100 can also include multiple fusers 60 to support applications such as overprinting, as known in the art.

In various embodiments, between fuser 60 and output tray 69, receiver 42B passes through finisher 70. Finisher 70 performs various paper-handling operations, such as folding, stapling, saddle-stitching, collating, and binding.

Printer 100 includes main printer apparatus logic and control unit (LCU) 99, which receives input signals from the various sensors associated with printer 100 and sends control signals to the components of printer 100. LCU 99 can include a microprocessor incorporating suitable look-up tables and control software executable by the LCU 99. It can also include a field-programmable gate array (FPGA), programmable logic device (PLD), microcontroller, or other digital control system. LCU 99 can include memory for storing control software and data. Sensors associated with the fusing assembly provide appropriate signals to the LCU 99. In response to the sensors, the LCU 99 issues command and control signals that adjust the heat or pressure within fusing nip 66 and other operating parameters of fuser 60 for receivers. This permits printer 100 to print on receivers of various thicknesses and surface finishes, such as glossy or matte.

Image data for writing by printer 100 can be processed by a raster image processor (RIP; not shown), which can include a color separation screen generator or generators. The output of the RIP can be stored in frame or line buffers for transmission of the color separation print data to each of the respective LED writers, e.g., for black (K), yellow (Y), magenta (M), cyan (C), and red (R), respectively. The RIP or color separation screen generator can be a part of printer 100 or remote therefrom. Image data processed by the RIP can be obtained from a color document scanner or a digital camera or produced by a computer or from a memory or network which typically includes image data representing a continuous image that needs to be reprocessed into halftone image data in order to be adequately represented by the printer. The RIP can perform image processing processes, e.g., color correction, in order to obtain the desired color print. Color image data is separated into the respective colors and converted by the RIP to halftone dot image data in the respective color using matrices, which comprise desired screen angles (measured counterclockwise from rightward, the +X direction) and screen rulings. The RIP can be a suitably-programmed computer or logic device and is adapted to employ stored or computed matrices and templates for processing separated color image data into rendered image data in the form of halftone information suitable for printing. These matrices can include a screen pattern memory (SPM).

Further details regarding printer 100 are provided in U.S. Pat. No. 6,608,641, issued on Aug. 19, 2003, to Peter S. Alexandrovich et al., and in U.S. Publication No. 2006/0133870, published on Jun. 22, 2006, by Yee S. Ng et al., the disclosures of which are incorporated herein by reference.

FIG. 2 shows more details of printing module 31 (FIG. 1), which is representative of printing modules 32, 33, 34, and 35 (FIG. 1). Primary charging subsystem 210 uniformly electrostatically charges photoreceptor 206 of imaging member 111, shown in the form of an imaging cylinder. Charging subsystem 210 includes a grid 213 having a selected voltage. Additional necessary components provided for control can be assembled about the various process elements of the respective printing modules. Meter 211 measures the uniform electrostatic charge provided by charging subsystem 210, and meter 212 measures the post-exposure surface potential within a patch area of a latent image formed from time to time in a non-image area on photoreceptor 206. Other meters and components can be included.

LCU 99 sends control signals to the charging subsystem 210, the exposure subsystem 220 (e.g., laser or LED writers), and the respective development station 225 of each printing module 31, 32, 33, 34, 35 (FIG. 1), among other components. Each printing module can also have its own respective controller (not shown) coupled to LCU 99.

Imaging member 111 includes photoreceptor 206. Photoreceptor 206 includes a photoconductive layer formed on an electrically conductive substrate. The photoconductive layer is an insulator in the substantial absence of light so that electric charges are retained on its surface. Upon exposure to light, the charge is dissipated. In various embodiments, photoreceptor 206 is part of, or disposed over, the surface of imaging member 111, which can be a plate, drum, or belt. Photoreceptors can include a homogeneous layer of a single material such as vitreous selenium or a composite layer containing a photoconductor and another material. Photoreceptors can also contain multiple layers.

An exposure subsystem 220 is provided for image-wise modulating the uniform electrostatic charge on photoreceptor 206 by exposing photoreceptor 206 to electromagnetic radiation to form a latent electrostatic image (e.g., of a separation corresponding to the color of toner deposited at this printing module). The uniformly-charged photoreceptor 206 is typically exposed to actinic radiation provided by selectively activating particular light sources in an LED array or a laser device outputting light directed at photoreceptor 206. In embodiments using laser devices, a rotating polygon (not shown) is used to scan one or more laser beam(s) across the photoreceptor in the fast-scan direction. One dot site is exposed at a time, and the intensity or duty cycle of the laser beam is varied at each dot site. In embodiments using an LED array, the array can include a plurality of LEDs arranged next to each other in a line, all dot sites in one row of dot sites on the photoreceptor can be selectively exposed simultaneously, and the intensity or duty cycle of each LED can be varied within a line exposure time to expose each dot site in the row during that line exposure time.

As used herein, an “engine pixel” is the smallest addressable unit on photoreceptor 206 or receiver 42 (FIG. 1) which the light source (e.g., laser or LED) can expose with a selected exposure different from the exposure of another engine pixel. Engine pixels can overlap, e.g., to increase addressability in the slow-scan direction (S). Each engine pixel has a corresponding engine pixel location, and the exposure applied to the engine pixel location is described by an engine pixel level.

The exposure subsystem 220 can be a write-white or write-black system. In a write-white or charged-area-development (CAD) system, the exposure dissipates charge on areas of photoreceptor 206 to which toner should not adhere. Toner particles are charged to be attracted to the charge remaining on photoreceptor 206. The exposed areas therefore correspond to white areas of a printed page. In a write-black or discharged-area development (DAD) system, the toner is charged to be attracted to a bias voltage applied to photoreceptor 206 and repelled from the charge on photoreceptor 206. Therefore, toner adheres to areas where the charge on photoreceptor 206 has been dissipated by exposure. The exposed areas therefore correspond to black areas of a printed page.

A development station 225 includes toning shell 226, which can be rotating or stationary, for applying toner of a selected color to the latent image on photoreceptor 206 to produce a visible image on photoreceptor 206. Development station 225 is electrically biased by a suitable respective voltage to develop the respective latent image, which voltage can be supplied by a power supply (not shown). Developer is provided to toning shell 226 by a supply system (not shown), e.g., a supply roller, auger, or belt. Toner is transferred by electrostatic forces from development station 225 to photoreceptor 206. These forces can include Coulombic forces between charged toner particles and the charged electrostatic latent image, and Lorentz forces on the charged toner particles due to the electric field produced by the bias voltages.

In an embodiment, development station 225 employs a two-component developer that includes toner particles and magnetic carrier particles. Development station 225 includes a magnetic core 227 to cause the magnetic carrier particles near toning shell 226 to form a “magnetic brush,” as known in the electrophotographic art. Magnetic core 227 can be stationary or rotating, and can rotate with a speed and direction the same as or different than the speed and direction of toning shell 226. Magnetic core 227 can be cylindrical or non-cylindrical, and can include a single magnet or a plurality of magnets or magnetic poles disposed around the circumference of magnetic core 227. Alternatively, magnetic core 227 can include an array of solenoids driven to provide a magnetic field of alternating direction. Magnetic core 227 preferably provides a magnetic field of varying magnitude and direction around the outer circumference of toning shell 226. Further details of magnetic core 227 can be found in U.S. Pat. No. 7,120,379 to Eck et al., issued Oct. 10, 2006, and in U.S. Publication No. 2002/0168200 to Stelter et al., published Nov. 14, 2002, the disclosures of which are incorporated herein by reference. Development station 225 can also employ a mono-component developer comprising toner, either magnetic or non-magnetic, without separate magnetic carrier particles.

Transfer subsystem 50 (FIG. 1) includes transfer backup member 113, and intermediate transfer member 112 for transferring the respective print image from photoreceptor 206 of imaging member 111 through a first transfer nip 201 to surface 216 of intermediate transfer member 112, and thence to a receiver (e.g., 42B) which receives the respective toned print images 38 from each printing module in superposition to form a composite image thereon. Print image 38 is e.g., a separation of one color, such as cyan. Receivers are transported by transport web 81. Transfer to a receiver is effected by an electrical field provided to transfer backup member 113 by power source 240, which is controlled by LCU 99. Receivers can be any objects or surfaces onto which toner can be transferred from imaging member 111 by application of the electric field. In this example, receiver 42B is shown prior to entry into second transfer nip 202, and receiver 42A is shown subsequent to transfer of the print image 38 onto receiver 42A.

As used herein, the term “development member” refers to the member(s) or subsystem(s) that provide toner to photoreceptor 206. In an embodiment, toning shell 226 is a development member. In another embodiment, toning shell 226 and magnetic core 227 together compose a development member.

Still referring to FIG. 2, toner is transferred from toning shell 226 to photoreceptor 206 in toning zone 236. As described above, toner is selectively supplied to the photoreceptor by toning shell 226. Toning shell 226 receives developer 234 from developer supply 230, which can include a mixer. Developer 234 includes toner particles and carrier particles.

Enclosure 252 includes barrier 254, which is spaced apart from photoreceptor 206. Enclosure 252 contains a gas, e.g., air. Working volume 250 is therefore defined within enclosure 252, and gap 256 is defined between barrier 254 and photoreceptor 206. A development member, as discussed above, is positioned in enclosure 252 for selectively applying toner to photoreceptor 206.

Gap 256 is selected so that a stream of gas is carried by rotating photoreceptor 206 into working volume 250 through gap 256. Toner particles in working volume 250 are therefore urged away from gap 256 to reduce passage of toner particles through gap 256, whereby contamination of, e.g., intermediate transfer member 112 is reduced.

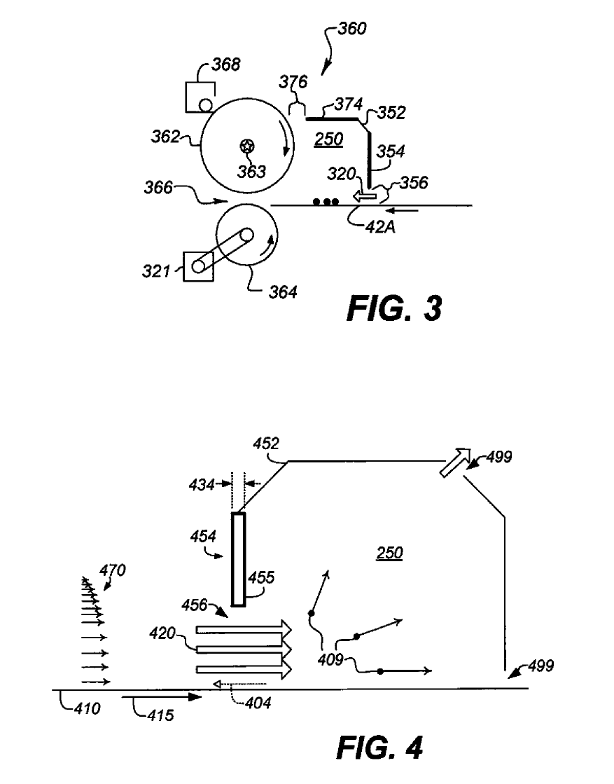

FIG. 3 shows apparatus for heating toner, for either fixing (fusing) or preheating, on a moving receiver 42A. Heating apparatus 360 includes rotatable heating member 362, e.g., a belt or drum, and rotatable pressure member 364 arranged with respect to member 362 to form nip 366. Heating member 362 can be heated externally or internally; an embodiment using an internal lamp heater 363 is shown.

Lubricating device 368 (e.g., a wick, web, or donor roller) applies a lubricant (e.g., DC200 fuser oil) to the surface of heating member 362. At least some of the lubricant, or a component thereof, vaporizes when heated on the heating member. For example, silicone oils produce low-molecular-weight volatiles when heated to temperatures greater than 150° C. Toner fusing typically takes place at temperatures between 140 and 210 C, so production of volatiles can occur in heating apparatus 360. Silicone volatiles can condense on surfaces various parts of printer 100 (FIG. 1), generating an oily residue. Volatiles can also cause inorganic silicon oxide decomposition products on corona charger wires, degrading print uniformity and image quality. Removal from silicone release oils of the low-molecular-weight compounds that become volatile increases the cost of the fluid. Retaining the volatiles in a confined area therefore advantageously permits the use of lower-cost release oils.

In addition, toner can deposit on fuser rollers such as heating member 362. Toner particles, or components thereof, can become volatile. For example, styrene-based toner particles can form volatiles having very unpleasant aromas. Polystyrene amides are also unpleasant in aroma. This embodiment retains those unpleasant aromas in the working volume, advantageously reducing operator dissatisfaction with the printer.

First barrier 354 is spaced apart from receiver 42A in advance of nip 366. First gap 356 is therefore defined between first barrier 354 and receiver 42A. Working volume 250 containing a gas is defined between first barrier 354, heating member 362, and receiver 42A. Drive 321 rotates heating member 362 or pressure member 364 to draw receiver 42A through nip 366.

The size and shape of first gap 356 are selected so that first stream 320 of gas is carried by moving receiver 42A into working volume 250 through first gap 256. Contaminant vapors in working volume 250 are therefore urged away from first gap 256. This reduces passage of the vapors through first gap 356, thereby reducing contamination outside working volume 250 due to the vapors.

In an embodiment, second barrier 374 is spaced apart from heating member 362, so that that second gap 376 is defined between second barrier 374 and heating member 362. Second gap 376 is selected so that a second stream of gas (not shown) is carried by rotating heating member 362 into working volume 250 through second gap 376 and the vapors in the working volume are urged away from second gap 376. In various embodiments, enclosure 352 defines or includes the first and second barriers 354, 374, and encloses working volume 250.

In various embodiments, working volume 250 further includes particles (not shown). For example, toner particles from receiver 42A can be present as contaminants in working volume 250. In these embodiments, the particles in the working volume are urged away from first gap 356 by the first stream 320 of gas flowing through first gap 356.

Various embodiments can be employed with other printer types, such as continuous inkjet, drop-on-demand inkjet, thermal, offset, and flexographic. A drop-on-demand inkjet printer useful with various embodiments is described in commonly-assigned U.S. application Ser. No. 12/642,883 by O'Leary et al., entitled “Ink fill port for inkjet ink tank,” the disclosure of which is incorporated herein by reference.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred embodiments thereof, but it will be understood that variations, combinations, and modifications can be effected by a person of ordinary skill in the art within the spirit and scope of the invention.

### PARTS LIST

31, 32, 33, 34, 35 printing module
38 print image
39 fused image
40 supply unit
42, 42A, 42B receiver
50 transfer subsystem
60 fuser
62 fusing roller
64 pressure roller
66 fusing nip
68 release fluid application substation
69 output tray
70 finisher
81 transport web
86 cleaning station
99 logic and control unit (LCU)
100 printer
111 imaging member
112 transfer member
113 transfer backup member
201 transfer nip
202 second transfer nip
206 photoreceptor
210 charging subsystem
211 meter
212 meter
213 grid
216 surface
220 exposure subsystem
225 development subsystem

### Parts List—Continued

226 toning shell
227 magnetic core
230 developer supply
234 developer
236 toning zone
240 power source
250 working volume
252 enclosure
254 barrier
256 gap
320 stream
321 drive
352 enclosure
354 barrier
356 gap
360 heating apparatus
362 heating member
363 heater
364 pressure member
366 nip
368 lubricating device
374 barrier
376 gap
404 backflow
409 contaminating substance particle
410 surface
415 direction
420 stream
434 thickness
452 enclosure

### Parts List—Continued

454 barrier
455 surface
456 gap
470 boundary layer flow velocity vectors
499 exit port

1. Apparatus for retaining a contaminating substance in a working volume containing a gas, comprising:
a. a movable surface disposed adjacent to the working volume; and
b. a barrier spaced apart from the surface ahead of the working volume in the direction of motion of the surface so that a gap is defined between the barrier and the surface; and
c. wherein the gap is selected so that a stream of gas is carried by the moving surface through the gap into the working volume and the contaminating substance in the working volume is urged away from the gap, thereby reducing flow of the contaminating substance through the gap.

2. The apparatus according to claim 1, wherein the contaminating substance substantially does not adhere to the surface of the barrier adjacent to the working volume.

3. The apparatus according to claim 1, wherein the barrier is above the working volume and the surface is moving downward.

4. The apparatus according to claim 1, wherein the stream of gas is more turbulent downstream of the gap than in the gap.

5. The apparatus according to claim 1, wherein the stream of gas is not urged into the working volume by a fan or blower.

6. The apparatus according to claim 1, further including an enclosure defining the barrier and enclosing the working volume.

7. The apparatus according to claim 6, wherein the enclosure includes one or more exit port(s) through which gas leaves the enclosed working volume, wherein the surface area of the exit port(s) is greater than or equal to the surface area of the gap.

8. The apparatus according to claim 1, wherein the surface is a closed surface of a rotatable member.

9. The apparatus according to claim 1, wherein the matter is solid.

10. The apparatus according to claim 1, wherein the moving surface is a surface of a belt or drum in an electrophotographic printer.

11. The apparatus according to claim 9, wherein the matter includes a colorant.

12. The apparatus according to claim 1, wherein the moving surface is an imaging surface of a receiver web in a printer.

13. The apparatus according to claim 1, wherein the matter is selected from the group consisting of toner particles, carrier particles, ink drops, wax drops, wax or ink streams, and liquid sheets.

14. The apparatus according to claim 1, wherein the gas includes nitrogen.

15. An electrophotographic development station, comprising:
a. a rotatable photoreceptor;
b. an enclosure including a barrier spaced apart from the photoreceptor, the enclosure containing a gas, so that a working volume is defined within the enclosure and a gap is defined between the barrier and the photoreceptor;
c. a development member in the enclosure for selectively applying toner to the photoreceptor; and
d. wherein the gap is selected so that a stream of gas is carried by the rotating photoreceptor into the working volume through the gap and toner particles in the working volume are urged away from the gap to reduce passage of toner particles through the gap, whereby contamination is reduced.

16. Apparatus for heating toner on a moving receiver, comprising:
a rotatable heating member and a rotatable pressure member arranged with respect to each other to form a nip;
a lubricating device for applying a lubricant to the surface of the heating member, wherein at least some of the lubricant, or a component thereof, vaporizes when heated on the heating member;
a first barrier spaced apart from the receiver in advance of the nip, so that a first gap is defined between the first barrier and the receiver, and a working volume containing a gas is defined between the first barrier, the heating member, and the receiver; and
a drive for rotating the heating member or pressure member to draw the receiver through the nip;
wherein the first gap is selected so that a first stream of gas is carried by the moving receiver into the working volume through the first gap and the vapors in the working volume are urged away from the first gap, thereby reducing passage of the vapors through the first gap, whereby contamination due to the vapors is reduced.

17. The apparatus according to claim 16, further including a second barrier spaced apart from the heating member, so that that a second gap is defined between the second barrier and the heating member,
wherein the second gap is selected so that a second stream of gas is carried by the rotating heating member into the working volume through the second gap and the vapors in the working volume are urged away from the second gap.

18. The apparatus according to claim 17, further including an enclosure defining the first and second barriers and enclosing the working volume.

19. The apparatus according to claim 16, wherein the working volume further includes particles, and the particles in the working volume are urged away from the first gap by the first stream of gas flowing through the first gap.
